(19) United States
(12) Patent Application Publication
(10) Pub. No.: US 2026/0289150 A1
(43) Pub. Date: Sep. 24, 2026

(54) METHOD AND SYSTEM FOR DESCRIPTOR EQUIVALENCE MODELLING

(71) Applicant: Tata Consultancy Services Limited, Mumbai (IN)

(72) Inventors: Sneha Srichand KAUSHIK, Bangalore (IN); Srikanth VENKATESH, Bangalore (IN); PRAJNA, Bangalore (IN); Abhishek MANJUNATH, Bangalore (IN)

(73) Assignee: Tata Consultancy Services Limited, Mumbai (IN)

(21) Appl. No.: 19/082,512

(22) Filed: Mar. 18, 2025

(30) Foreign Application Priority Data
Mar. 19, 2024 (IN) 202421020542

(51) Int. Cl. G06F 40/40; G06F 40/284; G06F 40/295; G06F 40/30

(52) U.S. Cl. CPC G06F 40/40; G06F 40/284; G06F 40/295; G06F 40/30

(57) ABSTRACT

This disclosure relates generally to the field of patent information retrieval, and, more particularly, to methods and system for descriptor equivalence modelling. The advent of technologies involving unique blend of technical application of NLP techniques, AI/ML is revolutionizing the field of analysis. In the field of IP analysis, a broader perspective is required to ensure all possible schematic and technical equivalents are covered, while also narrowing down to specific domain of the ideation element. The disclosed techniques for descriptor equivalence modelling, determine a plurality of descriptors based on several NLP techniques including text summarization, Named Entity Recognition (NER) technique, large language model (LLM) and a relationship extraction technique. Further several ML models are utilized to identify a connotative equivalence, a denotative equivalence, and a collocative equivalence that are augmented to the plurality of descriptors as equivalence based on an equivalence determination technique.

### PRIORITY CLAIM

This U.S. patent application claims priority under 35 U.S.C. § 119 to: Indian Patent Application 202421020542, filed on Mar. 19, 2024. The entire contents of the aforementioned application are incorporated herein by reference.

### TECHNICAL FIELD

The disclosure herein generally relates to the field of patent information retrieval, and, more particularly, to method and system for descriptor equivalence modelling.

### BACKGROUND

The advent of technologies such as Natural Language Processing (NLP), Artificial Intelligence (AI) and Machine Learning (ML) have revolutionized the application of computational techniques in the field of analysis and synthesis of natural language and speech. In the field of analysis and synthesis, textual analysis which otherwise would have been carried out manually leading to suboptimal results have been machine enabled thereby transforming the output, both in terms of scale and accuracy. One such interdisciplinary use case involving unique technical application of NLP techniques, AI, ML based approach and patent literature renders itself suitable for a range of possibilities in the domain of IP analytics.

IP Analytics involves extraction of valuable insights from an exhaustive set of patents and Non-Patent Literature (NPL) based on data analysis and statistical methods. IP Analytics with respect to patent includes whitespace analysis, Freedom-to-Operate (FTO), patent landscape analysis, patentability search and high competitor analysis among other analytical techniques. The IP analytics provides data-driven, evidence-based information that enables formulation of a better strategic decisions for product/patent development roadmap in corporate, law firms and patent offices to drive innovation policies, IP commercialization and licensing, research collaboration, and many others.

Patent analytics starts by conducting a search for relevant patent data and/or scientific literature. The common approach for conducting search is to understand and analyze the subject matter (ideation data) at hand, then identify the patentable aspects of the subject matter and keywords related to the patentable aspects using which search can be conducted. To obtain better search results, additional related technical aspects around the keywords must be identified and refined. For example, for an idea in the field of drone technology, the terms such as “Unmanned Aerial Vehicle,” “unmanned entity,” “mobile bodies,” “autonomous flying object,” “flight path,” “base station,” etc., must be included as related technical aspects. Furthermore, inconsistent terminologies, different meanings for same words in different applications or domains add on to the challenges in formulation of keywords for search query during patent analytics search. For example, the term ‘Virus’ can be used in both healthcare domain as well as computer security. So, for an idea in the field of computer security, the term virus should be interpreted as a malware, but the commonality of dangerous and undesirable character of virus in both the domains may be considered.

Hence a patent search requires a unique combination of words with similar meanings across different domains wherein the focus should be on technical engineering language. Further, after determination of key features and keywords, the synonyms must be identified. The determination of synonyms is not straight-forward and must have a greater focus on the domain, the supporting technology and semantic elements rather than lexical or direct dictionary equivalence. Considering these factors, the patent analysis search should encompass a broader perspective to ensure all possible schematic and technical equivalents are covered, while also narrowing down to specific domain of the idea. Therefore, for patent analytics it is adept to favor precision in analysis while at the same time situating the analysis in fuzzier context of broader activity.

The existing state of art techniques for search are mostly focused on generic search engines, or social media search or advertisement search or recommendation search engines, hence there is a requirement for a patent perspective search. Further although the existing patent search techniques uses databases, they require Subject Matter Expert (SME) efforts to identify keywords and synonyms and then formulate search strategy using them. The manual efforts are prone to error since for a given idea, there can be massive number of descriptors/keywords and each of these descriptors have numerous equivalences/synonyms. Conventional keyword extraction techniques are not suitable for identifying specific technical terms required for patent search since they only consider lexical meaning. Therefore, it is necessary to automatically identify the most relevant descriptors and their equivalences which are specific to one or more relevant domains to perform IP analytics efficiently and effectively.

### SUMMARY

Embodiments of the present disclosure present technological improvements as solutions to one or more of the above-mentioned technical problems recognized by the inventors in conventional systems. For example, in one embodiment, a method for descriptor equivalence modelling is provided. The method includes receiving an input data stream. The input data stream is associated with an ideation element comprising at least one of a textual data, a multimedia data and a combination thereof. Further, the method includes preprocessing the input data stream to determine a first set of data and a corresponding list of mentions using one or more natural language processing techniques. Further, the method includes determining a plurality of descriptors for the first set of data by: (i) determining a first set of data strings from the first set of data and the list of mentions, wherein the first set of data strings is associated with a technical interpretation of the ideation element based on a text summarization technique, (ii) associating one or more n-gram of the first set of data strings with a semantic token, wherein the semantic token categorizes each n-gram into one of a plurality of attributes based on a Named Entity Recognition (NER) technique, (iii) generating a first set of descriptors from each of the sub-strings of first set of data strings based on the associated semantic token using a large language model (LLM), wherein the first set of descriptors constitute a categorical scientific nomenclature of the ideation element; and (iv) identifying a set of afferent descriptors from the first set of descriptors based on a set of relationships among the first set of descriptors, wherein the set of relationships is determined based on a relationship extraction technique and the set of afferent descriptors represent the plurality of descriptors. Furthermore, the method includes augmenting a plurality of equivalences to each of the plurality of descriptors, wherein the plurality of equivalences are determined by: (i) identifying a first set of equivalences associated with each afferent descriptor in the set of afferent descriptors based on a plurality of ML models, wherein the first set of equivalence includes a connotative equivalence, a denotative equivalence, and a collocative equivalence; and (ii) identifying a second set of equivalences from the first set of equivalences based on an equivalence determination technique, wherein the second set equivalences represent the plurality of equivalences to be augmented to the of the plurality of descriptors.

In another aspect, a system for descriptor equivalence modelling is provided. The system includes: a memory storing instructions; one or more communication interfaces; and one or more hardware processors coupled to the memory via the one or more communication interfaces, wherein the one or more hardware processors are configured by the instructions to receive an input data stream. The input data stream is associated with an ideation element comprising at least one of a textual data, a multimedia data and a combination thereof. Further, the one or more hardware processors are configured to preprocess the input data stream to determine a first set of data and a corresponding list of mentions using one or more natural language processing techniques. Further, the one or more hardware processors are configured to determine a plurality of descriptors for the first set of data by: (i) determining a first set of data strings from the first set of data and the list of mentions, wherein the first set of data strings is associated with a technical interpretation of the ideation element based on a text summarization technique, (ii) associating one or more n-gram of the first set of data strings with a semantic token, wherein the semantic token categorizes each n-gram into one of a plurality of attributes based on a Named Entity Recognition (NER) technique, (iii) generating a first set of descriptors from each of the sub-strings of first set of data strings based on the associated semantic token using a large language model (LLM), wherein the first set of descriptors constitute a categorical scientific nomenclature of the ideation element; and (iv) identifying a set of afferent descriptors from the first set of descriptors based on a set of relationships among the first set of descriptors, wherein the set of relationships is determined based on a relationship extraction technique and the set of afferent descriptors represent the plurality of descriptors. Furthermore, the one or more hardware processors are configured to augment a plurality of equivalences to each of the plurality of descriptors, wherein the plurality of equivalences are determined by: (i) identifying a first set of equivalences associated with each afferent descriptor in the set of afferent descriptors based on a plurality of ML models, wherein the first set of equivalence includes a connotative equivalence, a denotative equivalence, and a collocative equivalence; and (ii) identifying a second set of equivalences from the first set of equivalences based on an equivalence determination technique, wherein the second set equivalences represent the plurality of equivalences to be augmented to the of the plurality of descriptors.

In yet another aspect, there are provided one or more non-transitory machine-readable information storage mediums comprising one or more instructions which when executed by one or more hardware processors cause a method for descriptor equivalence modelling. The method includes receiving an input data stream. The input data stream is associated with an ideation element comprising at least one of a textual data, a multimedia data and a combination thereof. Further, the method includes preprocessing the input data stream to determine a first set of data and a corresponding list of mentions using one or more natural language processing techniques. Further, the method includes determining a plurality of descriptors for the first set of data by: (i) determining a first set of data strings from the first set of data and the list of mentions, wherein the first set of data strings is associated with a technical interpretation of the ideation element based on a text summarization technique, (ii) associating one or more n-gram of the first set of data strings with a semantic token, wherein the semantic token categorizes each n-gram into one of a plurality of attributes based on a Named Entity Recognition (NER) technique, (iii) generating a first set of descriptors from each of the sub-strings of first set of data strings based on the associated semantic token using a large language model (LLM), wherein the first set of descriptors constitute a categorical scientific nomenclature of the ideation element; and (iv) identifying a set of afferent descriptors from the first set of descriptors based on a set of relationships among the first set of descriptors, wherein the set of relationships is determined based on a relationship extraction technique and the set of afferent descriptors represent the plurality of descriptors. Furthermore, the method includes augmenting a plurality of equivalences to each of the plurality of descriptors, wherein the plurality of equivalences are determined by: (i) identifying a first set of equivalences associated with each afferent descriptor in the set of afferent descriptors based on a plurality of ML models, wherein the first set of equivalence includes a connotative equivalence, a denotative equivalence, and a collocative equivalence; and (ii) identifying a second set of equivalences from the first set of equivalences based on an equivalence determination technique, wherein the second set equivalences represent the plurality of equivalences to be augmented to the of the plurality of descriptors.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for descriptor equivalence modelling, according to some embodiments of the present disclosure.

FIG. 2 is a functional block diagram illustrating a system comprising modules of the system of FIG. 1 for descriptor equivalence modelling, according to some embodiments of the present disclosure.

FIGS. 3A to 3C, collectively referred as FIG. 3, illustrates a flow diagram of a method for descriptor equivalence modelling, according to some embodiments of the present disclosure.

FIG. 4 is a flow diagram of a relationship extraction technique, according to some embodiments of the present disclosure.

FIG. 5 is a block diagram illustrating a plurality of semantic tokens and associated attributes, according to some embodiments of the present disclosure.

FIG. 6 is a block diagram illustrating an example of the plurality of semantic tokens and associated attributes, according to some embodiments of the present disclosure.

FIG. 7 illustrates relationships among a plurality of descriptors, according to some embodiments of the present disclosure.

FIG. 8 illustrates a plurality of equivalences augmented to a plurality of descriptors, according to some embodiments of the present disclosure.

FIG. 9 is a block diagram illustrating a use case example of the plurality of semantic tokens and associated attributes, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims.

IP analytics commences with the search process that involves identification of both patent and non-patent literature to understand, facilitate and undertake focused innovation and infrastructure development, wherein there is also a focus to understand if the product, process, or service in a specific domain has a potential intellectual property (IP) problem and further make suggestions for an alternate or design around approach or perhaps even drop the idea as it may be completely infringing existing patents. The search process begins with an understanding of the description of the product or patent idea or product specifications by a specialized team with practical knowledge of technology as well as law. The specialized team for patent searching requires specific skills and knowledge, such as technical expertise, legal expertise, information literacy, and analytical skills. The specialized team must have technical expertise to understand the technical aspects and terminology of the patents, and to identify the relevant patentable features and functions of ideation element. The specialized team must also be equipped with legal expertise to understand the legal aspects and implications of the relevant patents on the ideation element, and to assess the patentability and freedom to operate of the ideation element.

Once the specialized team understands the idea, it then identifies key features and further develops both a list of relevant search terms for a field of search along with multiple synonyms for the search terms. However, the generic determination of key features and synonyms from an input data is markedly different in IP domain. In an example scenario for understanding the process/workflow of IP analytics search, if a product claims a “coffee-based facewash,” and describes methods for preparing the facewash using coffee, then the domain would relate to cosmetics and not food/beverage industry. Therefore, some keywords are applicable to many diverse types of inventions across several domains. Hence while performing search, the key features, the key words and the corresponding synonyms would have to be with reference to the specific domain/application and in the “coffee-based facewash” example—the process refers to cosmetic industry/chemical industry and the process thereof and not refer to food/beverage industry. In another example scenario—“mouse” can refer to “computer” mouse and the “animal” mouse. Also since a patent is a techno-legal document, there is a need to focus on the technical engineering language rather than everyday frequently-used words—for an example, the usage of common words such as cars, auto or automobiles for land motor vehicles. Further, after determination of key features and keywords, synonyms must be determined which is not a straight-forward task since it must have a greater focus on the domain, the supporting technology and semantic elements rather than lexical/direct dictionary equivalence. Thus, the existing techniques of keyword and synonym extraction may not be effective since they consider only the lexical meaning of the words.

The existing state of art techniques for search are mostly focused on generic search engines, or social media search or advertisement search or recommendation search engines, hence there is a requirement for a patent perspective search. Further although the existing patent perspective techniques uses databases, they require Subject Matter Expert (SME) efforts to formulate keywords-synonyms. The manual efforts are therefore prone to error as for a given idea, there can be massive number of descriptors/keywords and each of these descriptors have numerous equivalences/synonyms. Therefore, it is necessary to automatically identify the most relevant descriptors and their equivalences which are specific to one or more relevant domains to perform IP Analytics efficiently and effectively.

The disclosure addresses the above cited challenges in patent perspective analytical search. The disclosed techniques determine a plurality of descriptors based on several NLP techniques including text summarization, Named Entity Recognition (NER) technique, Large Language Model (LLM) and a relationship extraction technique. Further several ML models are utilized to identify a first set of equivalences including a connotative equivalence, a denotative equivalence, and a collocative equivalence. The first set of equivalences are further filtered based on an equivalence determination technique and augmented to the plurality of descriptors to generate a descriptor-equivalence model.

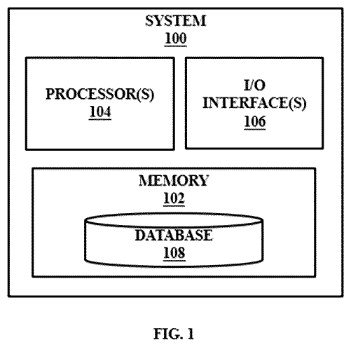

Referring now to the drawings, and more particularly to FIG. 1 through FIG. 9, where similar reference characters denote corresponding features consistently throughout the figures, there are shown preferred embodiments, and these embodiments are described in the context of the following exemplary system and/or method.

FIG. 1 is an exemplary block diagram of a system 100 for descriptor equivalence modelling in accordance with some embodiments of the present disclosure. In an embodiment, the system 100 includes a processor(s) 104, communication interface device(s), alternatively referred as input/output (I/O) interface(s) 106, and one or more data storage devices or a memory 102 operatively coupled to the processor(s) 104. The system 100 with one or more hardware processors is configured to execute functions of one or more functional blocks of the system 100.

Referring to the components of the system 100, in an embodiment, the processor(s) 104, can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 is configured to fetch and execute computer-readable instructions stored in the memory 102. In an embodiment, the system 100 can be implemented in a variety of computing systems including laptop computers, notebooks, hand-held devices such as mobile phones, workstations, mainframe computers, servers, a network cloud and the like.

The I/O interface(s) 106 can include a variety of software and hardware interfaces, for example, a web interface, a graphical user interface, a touch user interface (TUI) and the like and can facilitate multiple communications within a wide variety of networks N/W and protocol types, including wired networks, for example, LAN, cable, etc., and wireless networks, such as WLAN, cellular, or satellite. In an embodiment, the I/O interface (s) 106 can include one or more ports for connecting a number of devices (nodes) of the system 100 to one another or to another server.

The memory 102 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. Further, the memory 102 may include a database 108 configured to include information required for descriptor equivalence modelling. In an embodiment, the memory 102 stores different modules required to perform descriptor equivalence modelling including a pre-processor 202, a descriptor generator 204, a Large Language Model (LLM) 206, an equivalence generator 208, one or more Machine Learning (ML) models 210 and a descriptor-equivalence model 212. The memory 102 may comprise information pertaining to input(s)/output(s) of each step performed by the processor(s) 104 of the system 100 and methods of the present disclosure. In an embodiment, the database 108 may be external (not shown) to the system 100 and coupled to the system via the I/O interface 106. The system 100 supports various connectivity options such as BLUETOOTH®, USB, ZigBee and other cellular services. The network environment enables connection of various components of the system 100 using any communication link including Internet, WAN, MAN, and so on. In an exemplary embodiment, the system 100 is implemented to operate as a stand-alone device. In another embodiment, the system 100 may be implemented to work as a loosely coupled device to a smart computing environment.

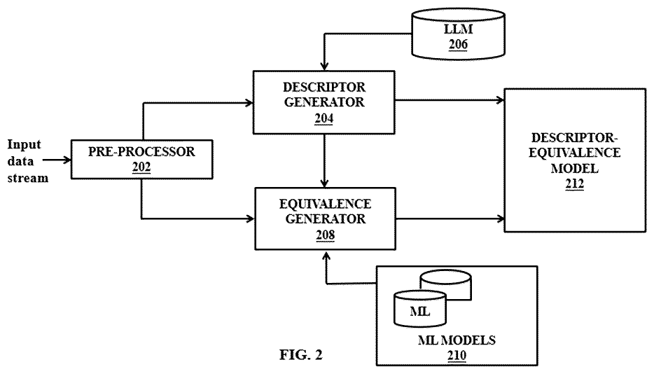

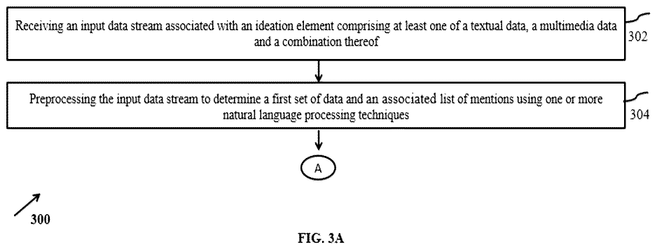

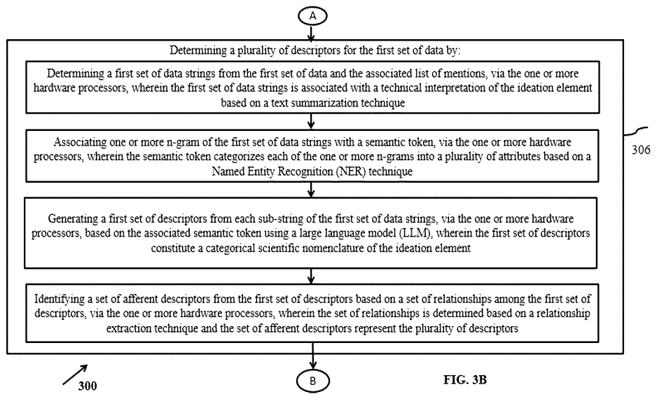

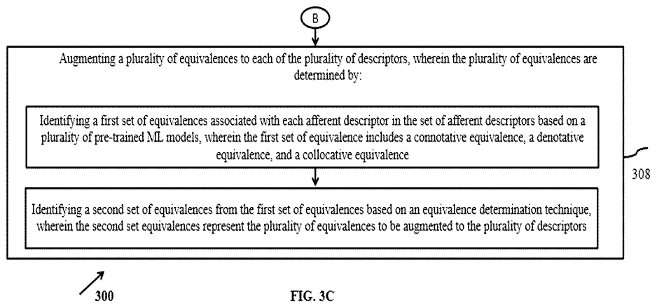

Functions of the components of system 100 are explained in conjunction with modules of the system 100 in FIG. 2 and flow diagram of FIG. 3 for descriptor equivalence modelling.

FIG. 2 is a functional block diagram of a system 200 comprising modules of the system of FIG. 1 for descriptor equivalence modelling, in accordance with some embodiments of the present disclosure. The system 200 is configured to receive an input data stream via one or more hardware processors. The input data stream is associated with an ideation element comprising at least one of a textual data, a multimedia data and a combination thereof. The system 200 comprises a pre-processor 202 configured to preprocess the input data stream to determine a first set of data and a corresponding list of mentions using one or more natural language processing techniques. The system 200 further comprises a descriptor generator 204 configured to determine a plurality of descriptors for the first set of data based on several techniques including a text summarization technique, a Named Entity Recognition (NER) technique, a Large Language Model (LLM) 206 and a relationship extraction technique. The plurality of descriptors are further processed by the descriptor generator 204 to identify a set of afferent descriptors. The system 200 further comprises an equivalence generator 208 configured for augmenting a plurality of equivalences to each of the plurality of descriptors by performing a plurality of steps including identifying a first set of equivalences associated with each afferent descriptor in the set of afferent descriptors based on a plurality of ML models, and further identifying a plurality of equivalences from the first set of equivalences based on an equivalence determination technique. The system 200 further comprises a descriptor-equivalence model 212 configured for displaying the plurality of descriptors along with the corresponding augmented plurality of equivalences.

The various modules of the system 100 and the FIG. 2 configured for descriptor equivalence modelling are implemented as at least one of a logically self-contained part of a software program, a self-contained hardware component, and/or, a self-contained hardware component with a logically self-contained part of a software program embedded into each of the hardware component that when executed perform the above method described herein.

FIGS. 3A-3C, collectively referred as FIG. 3, is an exemplary flow diagram illustrating a method 300 for descriptor equivalence modelling using the system 100 of FIG. 1 and system 200 of FIG. 2 according to an embodiment of the present disclosure. The steps of the method 300 of the present disclosure will now be explained with reference to the components of the system 100 of FIG. 1, the modules 202-212 as depicted in FIG. 2 and the flow diagrams as depicted in FIG. 3 for descriptor equivalence modelling. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

FIG. 3 illustrates a flow diagram of a method 300 for descriptor equivalence modelling, according to some embodiments of the present disclosure. At step 302 of method 300, an input data stream is received. The input data stream is associated with an ideation element. The format of the input data stream can be at least one of a textual data, a multimedia data and a combination thereof. In an embodiment, the ideation element includes information associated with a potentially novel and creative scientific innovation that can be applied to a process, technology, tool, framework, apparatus, device, system, metrics to solve a technical problem and a relation weightage index that indicates a relative importance of relations to be included during determination of the descriptors-equivalence.

An example ideation element comprises—a “Method for path planning and navigation of a drone” with the following textual description: “A drone-navigation and path planning technology is proposed based on self-organizing maps using neural networks. The self-organizing maps are different from existing artificial neural networks as they use a neighborhood function to preserve the topological properties of the input space. The artificial neural network (ANN) is trained using an existing unsupervised learning technique to produce a low dimensional discretized representation of the input of the training samples.”

In an embodiment, if the format of the input data stream is a multimedia data or a combination of textual and multimedia data, then, the input data stream has to be converted to textual data before pre-processing at step 304. The multimedia data could be in the form of images, video or audio. When the data is in the form of images, Optical Character Recognition (OCR) techniques are used to convert them into text. If the data is received as an audio file, then speech to text recognition techniques or analog to digital converters are used to generate the corresponding textual description. These techniques take sounds from the audio file and measures the waves in detail and filters them to distinguish between the corresponding sounds. The sounds are then broken down into thousands of a second and matched with phonemes (the sound units that distinguish one word from another in a given language). In the next step, the phonemes are passed through the network using a mathematical model that compares them with known words and sentences to produce textual data based on the most probable version of the sound. APIs such as Amazon transcribe, Azure Speech service, for example, may also be used to convert audio file to textual data in some embodiments. The video data is a combination of images (video frames) and audio files. The OCR technique is leveraged to detect the text in the video frames based on their frames rate and audio extracted from the video can be converted using speech to text recognition techniques or analog to digital converters.

At step 304 of method 300, the input data stream is preprocessed to determine a first set of data and a corresponding list of mentions by the pre-processor 202. The pre-processing is performed using one or more natural language processing techniques including one or more techniques for conversion of the input data stream to text format, text cleaning, tokenization, stop words removal, stemming/lemmatization, Part-of-speech (POS) tagging.

In an embodiment, the input data stream is processed to a uniform/standard format, for example, ideation element should be in String format and relationship weightage index should be in int or float format. Depending on the data and the requirement to convert/process the input data stream to the required standard formats several techniques are used. In an example scenario—a stop words removal is performed wherein ubiquitous occurable words are eliminated. Further stemming/lemmatization which is removal of the stem or suffices from the word is performed in order to create the index of a particular word or token. The one or more natural language processing techniques also includes a Part-of-speech (POS) tagging technique where each string or word is tagged to the particular entity of part-of-Speech based on the semantic meaning to arrive at tokenization.

Considering an example scenario of textual ideation element comprising description of the umbrella invention titled “Flexible wind/rain proof umbrella” as shared below:
“The improvised umbrella has an advanced rib design to support the umbrella during heavy rains/wind to prevent it from collapsing may have a design with several frames, ribs, ribs, rings joints, connectors and linkage bars.”

The first set of data for the umbrella invention titled “Flexible wind/rain proof umbrella” obtained after step 304 is as follows:
“The improvised umbrella has an advanced rib design to support the umbrella during heavy rains/wind to prevent it from collapsing may have a design with several frames, ribs, rings joints, connectors and linkage bars.”

In an embodiment, the list of mentions includes a field of invention, a universal classification identifier and one or more parallel domains. They are extracted from the first set of data. In an embodiment, the field of invention is identified using a Named Entity Recognition (NER) model. In another embodiment, an AI language model can be trained to identify field of invention. Most of times the keywords that are used for searching are applicable to many distinct types of inventions or domains, wherein in the example scenario of the umbrella invention titled “Flexible wind/rain proof umbrella,” the words rib, joints, connectors etc., may be applicable to healthcare or even construction domain if considered individually or in a specific combination. In another example “rotary technology” is used in both power tools and toothbrushes. Therefore, to avoid this pitfall of same words but different meanings in different applications/domain, the search strategy must consider a standard classification or the universal classification identifier such as International Patent Classification (IPC), the Cooperative Patent Classification (CPC) or United States Patent Classification (USPC). This will help in performing analysis on a wider range of prior arts by retrieving prior arts in related domains. The universal classification identifier is identified using REST (Representational State Transfer) API (Application Programming Interface), wherein a call is made to any one of the patent databases such as Open Patent Service, Espacenet, or any other such databases to retrieve the CPCs. The response data from API can be in any format such as XML, JSON etc. based on the API, then the input data is stored with the index of description in any one of data structure like dictionary or graph in order to retrieve the CPC details in future.

In an example scenario, for an umbrella invention titled “Flexible wind/rain proof umbrella,” the list of mentions would be determined as:
Field of invention—Mechanical, wind resistant umbrella
A universal classification identifier—A45B25/00 Details of umbrellas
One or more parallel domains—Healthcare

At step 306 of method 300, a plurality of descriptors is determined for the first set of data in the descriptor generator 204.

In an embodiment, the plurality of descriptors are used for IP analytics, specifically patent related IP Analytics. The IP analytics involves searching for related prior arts—including patent and non-patent literature based on the description of the ideation element. The description of the ideation element can be elaborate or summarized in few words that would be relevant to the context and domain of analytics being performed, and in the context of this disclosure the description of the ideation element would be captured in the plurality of descriptors. The process of determining plurality of descriptors is explained in steps 306A to 306D.

At step 306A of method 300, a first set of data strings is determined from the first set of data and the list of mentions. The first set of data strings is determined based on a text summarization technique. The first set of data strings is associated with a technical interpretation of the ideation element. In an embodiment, the text summarization technique utilizes a Bayesian Additive Regression Trees (BART) model for determining the first set of data strings. The BART model comprises of bidirectional encoders and left-to-right decoders which use a Transformer-based neural machine translation architecture in order to capture the summary efficiently from both the directions input. The BART model is also a denoising Auto encoder pretrained sequence-to-sequence method and utilizes masked language modelling for Natural Language Generation.

Consider an example first set of data (obtained after step 304) regarding “Personalized patient care” as shown below:
“Services in firms are pushing their traditional boundaries to build cross-industry ecosystems and create value at every stage of the customer journey. The evolution in technology supported by the right intelligence helps create innovative personalized offerings and experiences. In healthcare domain, patients seek high-quality care services anytime, anywhere, and at affordable costs. This calls for a connected, always-on, patient-centric delivery model. The requirement for this hyper personalization in the healthcare is enabled by a AI-driven intelligent machine learning, pattern recognition, and natural language processing-based solution for personalized patient care.”

In the above example of “Personalized patient care,” the first set of data strings associated with the technical interpretation of the ideation element as determined by the text summarization technique at step 306A is as follows:
“Hyper personalization for patient care enabled by an AI-driven intelligent machine learning, pattern recognition, and natural language processing-based solution.”

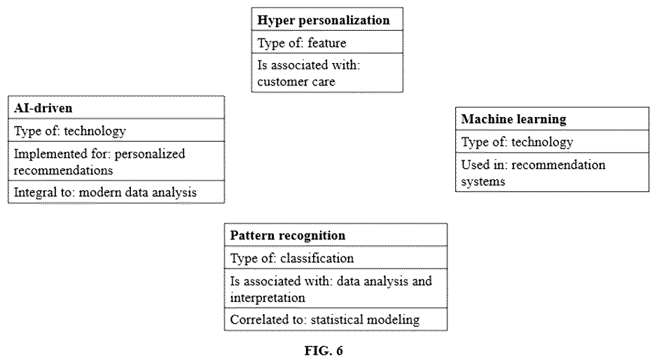

At step 306B of method 300, one or more n-grams of the first set of data strings is associated with a semantic token. The semantic token categorizes each n-gram into one of a plurality of attributes based on a Named Entity Recognition (NER) technique. In an embodiment, the semantic token is one of a character or property of the sub-string determined based on a NER technique. The existing NER techniques are not equipped to handle technical data for identification of semantic token. Hence the disclosed techniques improvise the existing NER models based on machine learning trainings such as unsupervised training to include attributes related to scientific and technical categories. The list of attributes indicates associations between the sub-string that specify how the sub-strings are connected and includes relationship associates such as ‘a type of,’ ‘is associated with,’ ‘is related to.’ The FIG. 5 illustrates a plurality of n-grams of the first set of data strings associated with a semantic token, wherein the semantic token categorizes each n-gram into one of a plurality of attributes. In the example scenario of “Personalized patient care,”, the n-grams of the first set of data strings and associated semantic token obtained after performing NER, and filtering out only technical content are illustrated in FIG. 6.

At step 306C of method 300, a first set of descriptors is generated from each of the one or more n-grams of the first set of data strings. The first set of descriptors constitute a categorical scientific nomenclature of the ideation element. The first set of descriptors that are derived may belong to multiple categories. However, in the context of present disclosure only words or terms that pertain to the category of scientific, technological, or innovative domain are relevant and necessary. To limit the words only to scientific and technological milieu, categorical scientific nomenclature is deployed in the LLM. Genre is a category used to classify text elements; usually by form, technique, or content. In the context of present disclosure, ‘genre’ deployed pertains to science, technology and innovation. A categorical scientific nomenclature is a sequenced group of text elements that is categorized by the text's genre. (genre being scientific, technological and innovation oriented). The categorical scientific nomenclature is aligned to the technical interpretation of the ideation element.

The first set of descriptors is generated based on the associated semantic token using a pre-trained large language model (LLM). In an embodiment, a LLM is a type of artificial intelligence (AI) model that can recognize and generate the categorical scientific nomenclature, among other tasks. It is built on a type of neural network called a transformer model which is pre-trained on huge sets of data. When given a prompt or asked a question, LLM can produce text in reply, wherein the text produced can be related to the categorical scientific nomenclature. Thus, at step 306C, a prompt such as “Provide words related to <<n-grams>>” or “Give me words related to <<n-grams>> in the field of <<field of invention>>” or “Provide a list of words related to <<n-grams as <<semantic token>>” or “Provide a list of words related to <<n-grams in the context <<semantic token>>” can be given to the LLM which replies with a list or a set of descriptors as output. Structure of the prompts can be pre-configured and stored as templates where <<n-grams is replaced with each of the one or more n-grams, <<field of invention>> is replaced with the field of invention comprised in the list of mentions, <<semantic token>> is replaced with the semantic token associated with the n-gram.

In an embodiment, a plurality of such prompts are given to the LLM and the results obtained from the LLM are combined to obtain the first set of descriptors. In an example scenario, considering the “Personalized patient care,” within which a bi-gram token of “hyper-personalization” is considered for explanation of the LLM. The bi-gram token “hyper-personalization” in the context of the example is used for healthcare domain. However, this token finds its use case in several other domains such as retail, banking, insurance, education and several others that involve customer involvement. In the patent search perspective, the mere related terms will not satisfy the requirement, but several related technical terms across the domain should be considered such as “Predictive analytics, customer segmentation, customer journey mapping, User profiling, customer persona, customer centric strategies, User-centric, Precision marketing, target campaigning, Contextualization, Targeted messaging, Behavioral targeting.”

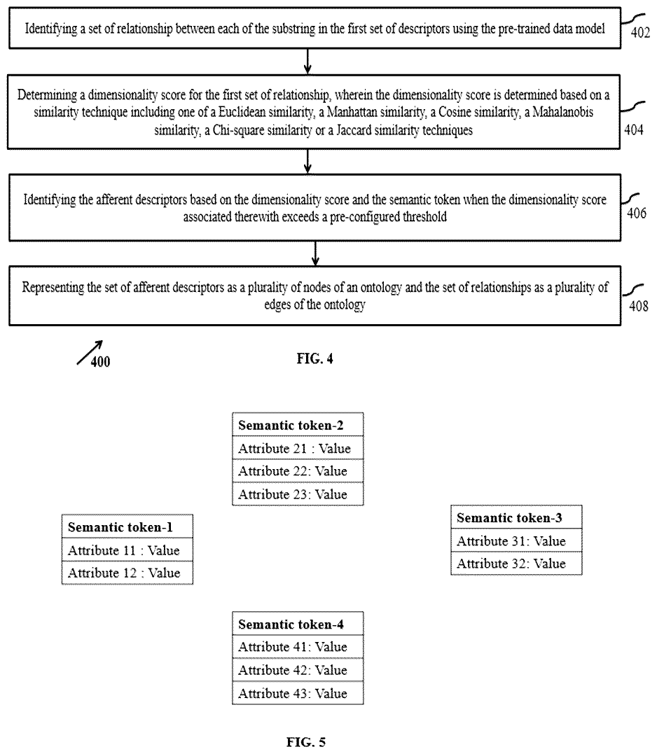

At step 306C of method 300, a set of afferent descriptors is identified from the first set of descriptors based on a set of relationships among the first set of descriptors. In the context of present disclosure, afferent descriptors are subset of the first set of descriptors that are leading towards domain ontology. Or, in other words, set of descriptors that are relevant to the context and domain of the ideation element on which analytics is being performed. Relationship between two descriptors indicates association or connection between the descriptors such as equivalence relation, reflexive relation, symmetric relation, transitive relation and the like. The set of relationships is determined based on a relationship extraction technique and the set of afferent descriptors represent the plurality of descriptors. The relationship extraction technique is explained using the flowchart of FIG. 4

At step 402 of method 400, a set of relationship is identified between each of the substring in the first set of descriptors using the pre-trained data model (alternatively referred as metamodel).

In an embodiment, the pre-trained data model is a universal super-set containing all possible relationships amongst descriptors in the context of science/technology. The data model is trained using a plurality of labeled data sets comprising a finite number of entities and their associated relationships. Over a period of time, the data model will be dynamically updated based on the new text data input, wherein the entity-relationships (descriptor relationships) and combinations thereof are foundational elements required to provide a suggestive set of configurations pertaining to descriptor equivalence matrices.

A relationship operator between the descriptors is critical for determination and optimization of the resultant patent data set for analysis because a mere listing of descriptors (as obtained from the LLM) can only yield a static enumeration of the descriptors; however, an entity-relationship model containing the underlying relationships and the causal correlations thereof is essential for optimized implementation.

In an embodiment, the set of relationship is identified between each of the substring in the first set of descriptors using the pre-trained data model based a causal relationship extraction technique, where an existence of a causal relationship exists between each of the substrings of the first set of descriptors is determined. The causal relationship is said to exist if there is a correlation between them the substrings based on examining the context and linguistic cues in the substrings to identify whether one event or entity is causing another. Once a causal relationship is identified, it is further classified into specific types or categories. For instance, causal relationships can be categorized as direct causation, indirect causation, correlation, reverse causation, or temporal causation. Further among the relationships identified only the relevant relations are retained based on the relation weightage index (comprised in the ideation element) that indicates a relative importance of relations is used to identify the required relationships. In an embodiment, the relative importance of relations is identified by a user of the system.

At step 404 of method 400, a dimensionality score is determined for the first set of relationship based on the semantic token. In an embodiment, the dimensionality score is determined based on a similarity technique including one of a Euclidean similarity, a Manhattan similarity, a Cosine similarity, a Mahalanobis similarity, a Chi-square similarity or a Jaccard similarity techniques and the like. The first set of descriptors are converted to word embedding vectors using a word embedding model such as Word2Vec. The word embedding model is pre-trained to model words into directional stream of data by language modelling technique to represent the words in multidimensional vector space. Further a similarity technique such as cosine similarity is used to calculate similarity between the set of relationships and the first set of descriptors here by measuring the cosine angle between the first set of descriptors of a product space within the set of relationships. The cosine similarity is defined as:

$$Cosine Similarity ( {d}_{1} , {d}_{2} ) = \frac{{d}_{1} \times {d}_{2}}{‖ {d}_{1} ‖ \times ‖ {d}_{2} ‖} \qquad ( 1 )$$

At step 406 of method 400, the afferent descriptors are identified based on the dimensionality score and the ideation element. The descriptors from the first set of descriptors having the dimensionality score associated therewith exceeding a pre-configured threshold value are identified as afferent descriptors. In an embodiment, the pre-configured threshold value is defined by a user based on their requirement.

At step 408 of method 400, the set of afferent descriptors are represented as a plurality of nodes of an ontology and the set of relationships as a plurality of edges of the ontology. In an embodiment, as shown in FIG. 6 the set of afferent descriptors are represented as a plurality of nodes of an ontology and the set of relationships descriptors are represented as a plurality of edges of the ontology.

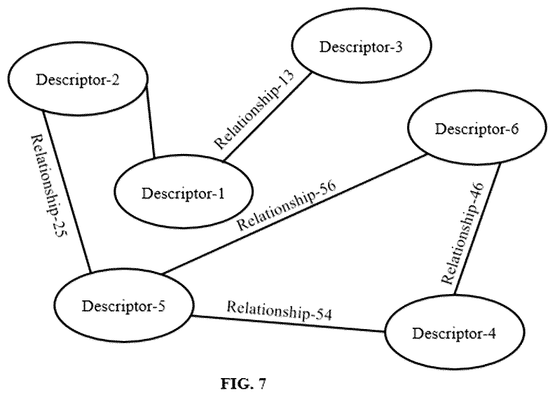

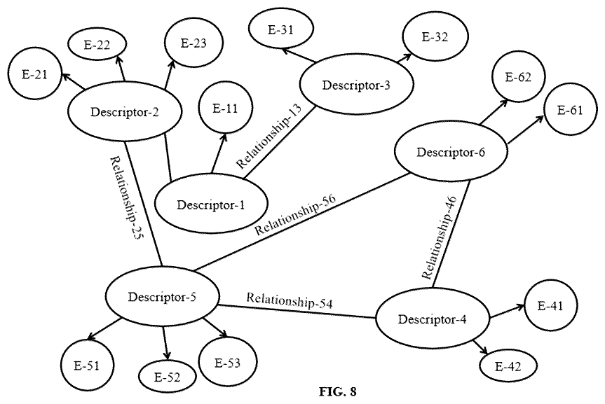

The FIG. 7 illustrates the set of afferent descriptors in an ontology, wherein the set of afferent descriptors are represented as a plurality of nodes—starting descriptor-1 to descriptor-6. Further the set of relationships descriptors are represented as a plurality of edges of the ontology in the same FIG. 7.

Referring to FIG. 3C, at step 308 of method 300, a plurality of equivalences are augmented to each of the plurality of descriptors.

In an embodiment, the plurality of equivalence are used along with the plurality of descriptors for IP analytics, specifically patent related IP Analytics. The equivalence terms is associated to the descriptors or is a term that are similar to the descriptors or belong to a similar technical domain of the ideation element that would refer to the descriptor.

The plurality of equivalences are determined by:
a) identifying a first set of equivalences associated with each afferent descriptor in the set of afferent descriptors based on a plurality of ML models, wherein the first set of equivalence includes a connotative equivalence, a denotative equivalence, and a collocative equivalence; and
b) identifying a second set of equivalences from the first set of equivalences based on an equivalence determination technique, wherein the second set equivalences represent the plurality of equivalences to be augmented to the of the plurality of descriptors.

The equivalence determination technique includes performing:
(a) a similarity technique between each afferent descriptor and the associated the first set of equivalences based a pre-defined threshold and
(b) a mutually exclusive aggregation technique involving a de-duplication routine to eliminate recurring equivalences.

In an embodiment, the first set of equivalences includes a connotative equivalence, a denotative equivalence, and a collocative equivalence that are determined individually. The contextual equivalence is a word that has a similar meaning to another word in a specific technical context. For instance, the words “shortcut” and “right-click” are contextual synonyms in the context of computer operations. Contextual synonyms are not always interchangeable, as they may have different connotations or nuances in different contexts. The connotative equivalence is determined based on one of a word embedding technique, and a distributional thesaurus. In an embodiment, Bidirectional Encoder Representations from Transformers (BERT) based self-supervised model trained on English language is used for connotative equivalence generation. The model comprises of MLM (Masked Language Modelling) and NSP (Next Sentence Prediction) based on masking the data by processing in in multi-direction format. In an example scenario for Virus from software domain, the connotative equivalence would be determined as Vulnerability, Bug, Attach, Program, software, etc. However, in case of Virus from healthcare the connotative equivalence would be determined as ‘virus’, ‘disease’, ‘pathogen’, ‘bacterium’, ‘name’.

The denotative equivalence of a word refers to the dictionary meaning also designated as lexical equivalence. The denotative equivalence is determined based on one of a semantic similarity measure, an ontology-based method, and a thesaurus-based approaches. In an embodiment, a dynamic repository is used to determine the denotative equivalence, wherein a plurality of lexical information is used to train in a dynamic repository with an index of the descriptor for each semantic synonyms. The dynamic repository is queried to retrieve the desired equivalence for the keywords with linear search iterating through every descriptor. The quantum for a particular descriptor can vary based on the lexical availability of equivalence. In another embodiment, denotative equivalence can be determined using NLTK (Natural Language Tool Kit) module by downloading the wordnet dictionary or Database which provides the synonyms or equivalence.

The collocative equivalence consists of the associations of a word based on account of the meaning of words which tend to occur in its specific environment, as in the case of affection and fondness, where these words share the similarity in the meaning. However, both words may be distinguished by the range of nouns with which they co-occur or collocate. The collocative equivalence is determined based on one of a semantic role labeling and a dependency parsing. In an embodiment, POS tagging is performed to identify two adjacent words as a collocation based on a pre-defined logical-linguistic model. Collocations can be considered to be semantically close if (1) their grammatical and semantic features satisfy the predicate of equivalence and (2) the words of two collocations are synonymous in pairs. The predicate specifies grammatical and semantic characteristics of the dependent word in collocations which is defined by the field of invention and the universal classification identifier.

Upon identifying the first set of equivalences, then a second set of equivalences is determined which represent the plurality of equivalences to be augmented to the of the plurality of descriptors. The second set of equivalences is determined based on an equivalence determination technique which includes performing:
(a) A similarity technique between each afferent descriptor and the associated the first set of equivalences based on a pre-defined threshold and
(b) A mutually exclusive aggregation technique involving a de-duplication routine to eliminate recurring equivalences.

In an embodiment, a similarity technique includes one of a Euclidean similarity, a Manhattan similarity, a Cosine similarity, a Mahalanobis similarity, a Chi-square similarity, a Jaccard similarity techniques and the like is used to determine a similarity score between each afferent descriptor and the associated the first set of equivalences. If the similarity score of a particular pair of the afferent descriptor and the associated the first set of equivalences exceeds a pre-configured threshold then the particular pair of the afferent descriptor and the associated the first set of equivalences is retained. Further a cardinality score is determined for the retained pair of afferent descriptors and the associated first set of equivalences. The cardinality score is defined as the number of elements in a mathematical set. It can be finite or infinite. In an example scenario, the cardinality of the set A={a, b, c, d, e, f} is equal to 6 because set A has six elements. The cardinality of a set is also known as the size of the second set of equivalences.

Further a mutually exclusive aggregation is performed for the retained pair of afferent descriptors and the associated the first set of equivalences. The mutually exclusive aggregation involves a de-duplication routine to eliminate recurring equivalences. The second set equivalences represent the plurality of equivalences to be augmented to the of the plurality of descriptors.

The plurality of descriptors along with the corresponding augmented plurality of equivalences is displayed by the descriptor-equivalence model 212. The descriptor-equivalence model would be used for the search query formation during IP Analytics. The FIG. 8 illustrates the descriptor-equivalence model in an ontology, wherein the set of afferent descriptors are represented as a plurality of nodes—starting from descriptor-1 to descriptor-6. Each descriptor is augmented with a plurality of equivalences. In the FIG. 8, the descriptor-1 (D-1) is associated with one equivalence (E-11), the descriptor-3 (D-3) is associated with two equivalence (E-31 and E-32) and the descriptor-5 (D-5) is associated with three equivalence (E-51, E-52 and E-53).

### Use Case

In an example scenario, an audio input data stream (audio clip) comprising the ideation element is received at step 302. The audio clip is converted into textual note using a speech-to-text converter and pre-processing is performed in the pre-processor 202. The ideation element titled “digital twin solution for emissions optimization” is as follows:
“The threat of climate change has become extremely critical for any industry to ignore. Despite tracking scope emission & their respective sources, the path of sustainability is still unclear which is where the digital twin solution can be leveraged to enable risk-free experimentation around new sustainability initiatives. The proposed digital twin solution for emissions optimization is an effective tool to test new strategies around sustainability, refine the investment plans & understand Human-Carbon interactions on how to nudge customers to take up greener energy alternatives. In the context of electric vehicles, digital twin solution could be a digital model of the vehicle components, the battery system, or the entire vehicle itself. The idea is to digitally replicate the real-world scenario to enable real-time monitoring, simulation, and optimization. By using digital twins in testing, engineers can simulate an EV's operation under various conditions which will help uncover potential problems without the need for multiple physical prototypes. Extreme conditions can also be simulated, which are expensive and hard to physically replicate.”

The first set of data and the corresponding list of mentions obtained after pre-processing the ideation element at step 304 are:

### The First Set of Data:

“The threat of climate change has become extremely critical for any industry to ignore. Despite tracking scope emission & their respective sources, the path of sustainability is still unclear which is where the digital twin solution can be leveraged to enable risk-free experimentation around new sustainability initiatives. The proposed digital twin solution for emissions optimization is an effective tool to test new strategies around sustainability, refine the investment plans & understand Human-Carbon interactions on how to nudge customers to take up greener energy alternatives. In the context of electric vehicles, digital twin solution could be a digital model of the vehicle components, the battery system, or the entire vehicle itself. The idea is to digitally replicate the real-world scenario to enable real-time monitoring, simulation, and optimization. By using digital twins in testing, engineers can simulate an EV's operation under various conditions which will help uncover potential problems without the need for multiple physical prototypes. Extreme conditions can also be simulated, which are expensive and hard to physically replicate.”

### List of Mentions:

Field of invention—Emission optimization using digital twins Universal classification identifier
B60L: Exchange of energy storage elements in electric vehicles
Y02P: Enabling technologies with a potential contribution to greenhouse gas [GHG]emissions mitigation.
G16Y30/00: IoT infrastructure
One or more parallel domains—Sustainability, digital twin, Supply chain, healthcare domain (twin), automotives, predictive maintenance.

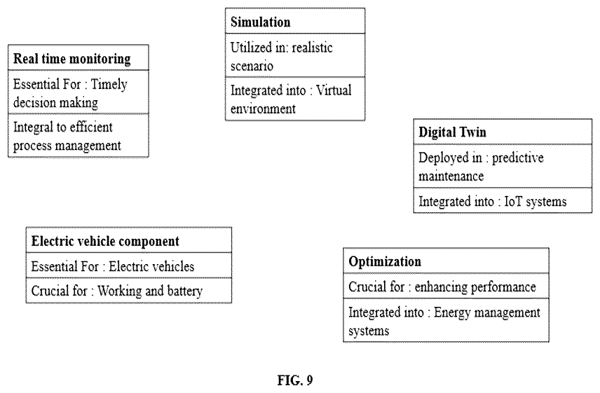

Further the plurality of descriptors are determined at step 306 as follow:
(a) Determining a first set of data strings as:
“Real-time monitoring, simulation, and optimization of the electric vehicle components using digital twins.”
(b) Identifying semantic token that categorizes each n-gram into one of a plurality of attributes, wherein the n-grams from the first set of data strings are: Real-time monitoring, simulation, optimization, electric vehicle components and digital twins
The semantic tokens along with the attributes are illustrated in FIG. 9.
(c) First set of descriptors: The first set of descriptors are generated for all the n-grams. However, one single n-gram would be considered in this section to reduce the complexity and enable easy understanding of the disclosure. Considering an use-case example of the bi-gram “digital twin”, the first set of descriptors are identified which are scientific, technological or innovative domain relevant to digital twin as shown in table 1 below:

TABLE 1
Bi-Gram “digital twin”
with first set of
descriptors
Digital Twin
Interacting systems
Transaction platforms
Edge device
Digital knowledge
Healthcare
Industry
Twin clinical trial
Sensor data
Block chain
Cyber security

(d) Set of afferent descriptors
The set of afferent descriptors are identified from the first set of descriptors based on a set of relationships among the first set of descriptors, wherein the set of relationships is determined based on a relationship extraction technique. In the example of the bi-gram ‘digital twin’, set of afferent descriptors are identified by retaining words related to the monitoring, simulation, optimization, electric vehicle components while the rest of the related concepts are eliminated.

TABLE 2
The plurality of
descriptors for
digital twin.
Digital Twin
Edge device
Sensor data
Block chain
Cyber security

Further the plurality of equivalences is augmented to each of the plurality of descriptors in the following steps: A first set of equivalences is identified for all the descriptors for digital twin. However, only one descriptor would be considered in this example to reduce the complexity and enable easy understanding of the disclosure. Connotative equivalences are listed in tables 3A and 3B.

TABLE 3A
Edge device
Mirror model
Replica system
Dual representation
Virtual counterpart

TABLE 3B
Sensor Data
Industrial Internet
Industrial machine
State Value
Automobile data collection
Analog sensors
Digital twin
Sensor Kit
Network sensitive
data collection

Denotative equivalences are listed in tables 4A and 4B.

TABLE 4A
Edge device
Twin technology
Virtual Counterpart
IoT
Asset Digital Twins
Digital replica

TABLE 4B
Sensor Data
Data from sensors
Sensory data
Environmental data
Signal data
Wearable device
Detector
alarm
Trigger
Electric Eye
Photo electric cell

Collocative equivalences are listed in tables 5A and 5B.

TABLE 5A
Edge device
Data synchronization
Simulation counterpart
Cyber-physical replica
IoT integration
Real-time simulation

TABLE 5B
Sensor Data
Sensor readings
Sensor information
Sensor measurements
Data from sensors
Detector information
Sensing data

A second set of equivalences identified from the first set of equivalences (of the “digital twin” descriptor) are listed in table 6.

TABLE 6
Digital twin-Edge device
Twin technology
Mirror model
Replica system
Virtual counterpart
Asset Digital Twins
Digital replica
Simulation counterpart
IoT integration
Cyber-physical replica

Table 6 gives the set of equivalences augmented to the afferent descriptor ‘digital twin’ in an ontology. In an embodiment, the descriptors and their corresponding equivalences may be presented in matrix form. In another embodiment, the descriptors and their corresponding equivalences may be presented as a knowledge graph for easy visualization.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiment of present disclosure herein addresses unresolved problem of modelling descriptor-equivalence to be utilized for IP Analytics. The embodiment thus provides techniques to determine a plurality of descriptors and corresponding equivalence. In the field of IP analysis, a broader perspective is required to ensure all possible schematic and technical equivalents are covered, while also narrowing down to specific domain of the ideation element. The disclosed techniques for descriptor equivalence modelling, determine a plurality of descriptors based on several NLP techniques including text summarization, Named Entity Recognition (NER) technique, large language model (LLM) and a relationship extraction technique. Further several ML models are utilized to identify a connotative equivalence, a denotative equivalence, and a collocative equivalence that are augmented to the plurality of descriptors as equivalence based on an equivalence determination technique.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for a descriptor equivalence modelling, comprising:
receiving an input data stream via one or more hardware processors, wherein the input data stream is associated with an ideation element comprising at least one of i) a textual data, ii) a multimedia data and iii) a combination thereof;
preprocessing the input data stream to determine a first set of data and an associated list of mentions, via the one or more hardware processors, using one or more natural language processing techniques;
determining a plurality of descriptors for the first set of data by:
determining a first set of data strings from the first set of data and the associated list of mentions, via the one or more hardware processors, wherein the first set of data strings is associated with a technical interpretation of the ideation element based on a text summarization technique;
associating one or more n-gram of the first set of data strings with a semantic token, via the one or more hardware processors, wherein the semantic token categorizes each of the one or more n-grams into a plurality of attributes based on a Named Entity Recognition (NER) technique;
generating a first set of descriptors from each sub-string of the first set of data strings, via the one or more hardware processors, based on the associated semantic token using a large language model (LLM), wherein the first set of descriptors constitute a categorical scientific nomenclature of the ideation element; and
identifying a set of afferent descriptors from the first set of descriptors based on a set of relationships among the first set of descriptors, via the one or more hardware processors, wherein the set of relationships is determined based on a relationship extraction technique and the set of afferent descriptors represent the plurality of descriptors;
augmenting a plurality of equivalences to each of the plurality of descriptors, via the one or more hardware processors, wherein the plurality of equivalences are determined by:
(i) identifying a first set of equivalences associated with each afferent descriptor in the set of afferent descriptors based on a plurality of pre-trained ML models, wherein the first set of equivalence includes a connotative equivalence, a denotative equivalence, and a collocative equivalence; and
(ii) identifying a second set of equivalences from the first set of equivalences based on an equivalence determination technique, wherein the second set equivalences represent the plurality of equivalences to be augmented to the plurality of descriptors.

2. The processor implemented method of claim 1, wherein the ideation element includes:
information associated with a potentially novel and creative scientific innovation that can be applied to a process, technology, tool, framework, apparatus, device, system, metrics to solve a technical problem and,
a relation weightage index that indicates a relative importance of relations to be included during determination of the descriptors-equivalence.

3. The processor implemented method of claim 1, wherein:
the list of mentions includes a field of invention, a universal classification identifier and one or more parallel domains;
the one or more natural language processing techniques includes one or more techniques for conversion to text format, text cleaning, tokenization, stop words removal, stemming/lemmatization, Part-of-speech (POS) tagging;
the semantic token is one of a character or property of the sub-string determined based on a NER technique, and
the list of attributes indicates associations between the sub-string that specify how the sub-string are connected and includes relationship associates such as ‘a type of,’ ‘is associated with,’ ‘is related to’.

4. The processor implemented method of claim 1, wherein the relationship extraction technique includes:
identifying a set of relationship between each of the substring in the first set of descriptors using the pre-trained data model;
determining a dimensionality score for the first set of relationship, wherein the dimensionality score is determined based on a similarity technique including one of a Euclidean similarity, a Manhattan similarity, a Cosine similarity, a Mahalanobis similarity, a Chi-square similarity or a Jaccard similarity techniques; and
identifying the afferent descriptors based on the dimensionality score and the semantic token when the dimensionality score associated therewith exceeds a pre-configured threshold.

5. The processor implemented method of claim 1, wherein:
the connotative equivalence is determined based on one of a word embedding technique, and a distributional thesaurus;
the denotative equivalence is determined based on one of a semantic similarity measure, an ontology-based method, and a thesaurus-based approaches; and
a collocative equivalence is determined based on one of a semantic role labeling and a dependency parsing.

6. The processor implemented method of claim 1, wherein the equivalence determination technique includes performing (a) a similarity technique between each afferent descriptor and the associated the first set of equivalences based a pre-defined threshold and (b) a mutually exclusive aggregation technique involving a de-duplication routine to eliminate recurring equivalences.

7. A system, comprising:
a memory storing instructions;
one or more communication interfaces; and
one or more hardware processors coupled to the memory via the one or more communication interfaces, wherein the one or more hardware processors are configured by the instructions to:
receive an input data stream via one or more hardware processors wherein the input data stream is associated with an ideation element comprising at least one of i) a textual data, ii) a multimedia data and iii) a combination thereof;
preprocess the input data stream to determine a first set of data and an associated list of mentions, via the one or more hardware processors, using one or more natural language processing techniques;
determine a plurality of descriptors for the first set of data by:
determining a first set of data strings from the first set of data and the associated list of mentions, via the one or more hardware processors, wherein the first set of data strings is associated with a technical interpretation of the ideation element based on a text summarization technique;
associating one or more n-gram of the first set of data strings with a semantic token, via the one or more hardware processors, wherein the semantic token categorizes each of the one or more n-grams into a plurality of attributes based on a Named Entity Recognition (NER) technique;
generating a first set of descriptors from each sub-string of the first set of data strings, via the one or more hardware processors, based on the associated semantic token using a large language model (LLM), wherein the first set of descriptors constitute a categorical scientific nomenclature of the ideation element; and
identifying a set of afferent descriptors from the first set of descriptors based on a set of relationships among the first set of descriptors, via the one or more hardware processors, wherein the set of relationships is determined based on a relationship extraction technique and the set of afferent descriptors represent the plurality of descriptors;
augment a plurality of equivalences to each of the plurality of descriptors, via the one or more hardware processors, wherein the plurality of equivalences are determined by:
(i) identifying a first set of equivalences associated with each afferent descriptor in the set of afferent descriptors based on a plurality of pre-trained ML models, wherein the first set of equivalence includes a connotative equivalence, a denotative equivalence, and a collocative equivalence; and
(ii) identifying a second set of equivalences from the first set of equivalences based on an equivalence determination technique, wherein the second set equivalences represent the plurality of equivalences to be augmented to the plurality of descriptors.

8. The system of claim 7, wherein the ideation element includes:
information associated with a potentially novel and creative scientific innovation that can be applied to a process, technology, tool, framework, apparatus, device, system, metrics to solve a technical problem and,
a relation weightage index that indicates a relative importance of relations to be included during determination of the descriptors-equivalence.

9. The system of claim 7, wherein:
the list of mentions includes a field of invention, a universal classification identifier and one or more parallel domains;
the one or more natural language processing techniques includes one or more techniques for conversion to text format, text cleaning, tokenization, stop words removal, stemming/lemmatization, Part-of-speech (POS) tagging;
the semantic token is one of a character or property of the sub-string determined based on a NER technique, and
the list of attributes indicates associations between the sub-string that specify how the sub-string are connected and includes relationship associates such as ‘a type of,’ ‘is associated with,’ ‘is related to’.

10. The system of claim 7, wherein the relationship extraction technique includes:
identifying a set of relationship between each of the substring in the first set of descriptors using the pre-trained data model;
determining a dimensionality score for the first set of relationship, wherein the dimensionality score is determined based on a similarity technique including one of a Euclidean similarity, a Manhattan similarity, a Cosine similarity, a Mahalanobis similarity, a Chi-square similarity or a Jaccard similarity techniques; and
identifying the afferent descriptors based on the dimensionality score and the semantic token when the dimensionality score associated therewith exceeds a pre-configured threshold.

11. The system of claim 7, wherein:
the connotative equivalence is determined based on one of a word embedding technique, and a distributional thesaurus;
the denotative equivalence is determined based on one of a semantic similarity measure, an ontology-based method, and a thesaurus-based approaches; and
a collocative equivalence is determined based on one of a semantic role labeling and a dependency parsing.

12. The system of claim 7, wherein the equivalence determination technique includes performing (a) a similarity technique between each afferent descriptor and the associated the first set of equivalences based a pre-defined threshold and (b) a mutually exclusive aggregation technique involving a de-duplication routine to eliminate recurring equivalences.

13. One or more non-transitory machine-readable information storage mediums comprising one or more instructions which when executed by one or more hardware processors cause:
receiving an input data stream via one or more hardware processors wherein the input data stream is associated with an ideation element comprising at least one of i) a textual data, ii) a multimedia data and iii) a combination thereof;
preprocessing the input data stream to determine a first set of data and an associated list of mentions, via the one or more hardware processors, using one or more natural language processing techniques;
determining a plurality of descriptors for the first set of data by:
determining a first set of data strings from the first set of data and the associated list of mentions, via the one or more hardware processors, wherein the first set of data strings is associated with a technical interpretation of the ideation element based on a text summarization technique;
associating one or more n-gram of the first set of data strings with a semantic token, via the one or more hardware processors, wherein the semantic token categorizes each of the one or more n-grams into a plurality of attributes based on a Named Entity Recognition (NER) technique;
generating a first set of descriptors from each sub-string of the first set of data strings, via the one or more hardware processors, based on the associated semantic token using a large language model (LLM), wherein the first set of descriptors constitute a categorical scientific nomenclature of the ideation element; and
identifying a set of afferent descriptors from the first set of descriptors based on a set of relationships among the first set of descriptors, via the one or more hardware processors, wherein the set of relationships is determined based on a relationship extraction technique and the set of afferent descriptors represent the plurality of descriptors;
augmenting a plurality of equivalences to each of the plurality of descriptors, via the one or more hardware processors, wherein the plurality of equivalences are determined by:
(iii) identifying a first set of equivalences associated with each afferent descriptor in the set of afferent descriptors based on a plurality of pre-trained ML models, wherein the first set of equivalence includes a connotative equivalence, a denotative equivalence, and a collocative equivalence; and
(iv) identifying a second set of equivalences from the first set of equivalences based on an equivalence determination technique, wherein the second set equivalences represent the plurality of equivalences to be augmented to the plurality of descriptors.

14. The one or more non-transitory machine-readable information storage mediums of claim 13, wherein the ideation element includes:
information associated with a potentially novel and creative scientific innovation that can be applied to a process, technology, tool, framework, apparatus, device, system, metrics to solve a technical problem and,
a relation weightage index that indicates a relative importance of relations to be included during determination of the descriptors-equivalence.

15. The one or more non-transitory machine-readable information storage mediums of claim 13, wherein:
the list of mentions includes a field of invention, a universal classification identifier and one or more parallel domains;
the one or more natural language processing techniques includes one or more techniques for conversion to text format, text cleaning, tokenization, stop words removal, stemming/lemmatization, Part-of-speech (POS) tagging;
the semantic token is one of a character or property of the sub-string determined based on a NER technique, and
the list of attributes indicates associations between the sub-string that specify how the sub-string are connected and includes relationship associates such as ‘a type of,’ ‘is associated with,’ ‘is related to’.

16. The one or more non-transitory machine-readable information storage mediums of claim 13, wherein the relationship extraction technique includes:
identifying a set of relationship between each of the substring in the first set of descriptors using the pre-trained data model;
determining a dimensionality score for the first set of relationship, wherein the dimensionality score is determined based on a similarity technique including one of a Euclidean similarity, a Manhattan similarity, a Cosine similarity, a Mahalanobis similarity, a Chi-square similarity or a Jaccard similarity techniques; and
identifying the afferent descriptors based on the dimensionality score and the semantic token when the dimensionality score associated therewith exceeds a pre-configured threshold.

17. The one or more non-transitory machine-readable information storage mediums of claim 13, wherein:
the connotative equivalence is determined based on one of a word embedding technique, and a distributional thesaurus;
the denotative equivalence is determined based on one of a semantic similarity measure, an ontology-based method, and a thesaurus-based approaches; and
a collocative equivalence is determined based on one of a semantic role labeling and a dependency parsing.

18. The one or more non-transitory machine-readable information storage mediums of claim 13, wherein the equivalence determination technique includes performing (a) a similarity technique between each afferent descriptor and the associated the first set of equivalences based a pre-defined threshold and (b) a mutually exclusive aggregation technique involving a de-duplication routine to eliminate recurring equivalences.
